(19) United States
(12) Patent Application Publication
(10) Pub. No.: US 2011/0291935 A1
(43) Pub. Date: Dec. 1, 2011

(54) WIRELESS KEYBOARD WITH PIVOTAL CAMERA AND MICRO-PROJECTOR

(75) Inventor: YUNG-LUNG LIU, Ta Ya Shiang (TW)

(73) Assignee: Sunrex Technology Corp., Ta Ya Shiang (TW)

(21) Appl. No.: 12/787,886

(22) Filed: May 26, 2010

(51) Int. Cl. G06F 3/02; H04N 5/225

(52) U.S. Cl. 345/168; 348/333.1; 348/E05.024

(57) ABSTRACT

A wireless keyboard in cooperation with a PC having a display includes a housing; a plurality of keys mounted on the housing; a micro-projector pivotably mounted on a front end of the housing; a camera pivotably mounted on the front end of the housing besides the micro-projector; and a touchpad mounted besides the keys.

### BACKGROUND OF THE INVENTION

1. Field of Invention

The invention relates to wireless keyboards and more particularly to a wireless keyboard having pivotal camera and micro-projector.

2. Description of Related Art

Projector and personal computer (PC) are often required in a meeting or briefing nowadays. An individual may feel inconvenient if no projector is available if such need arises. A typical keyboard has a plurality of keys for data input or instruction input. The individual may key in what is shown on a screen hanged on a wall when a meeting or briefing is being held.

A type of laptop having a pivotal micro-projector is commercially available. The micro-projector is pivotal and mounted on a top edge of a display of the laptop. It has the benefits of being used as a typical projector if such need arises in a meeting or briefing.

However, the addition of the micro-projector inevitably further increases the manufacturing cost since other components (e.g., motherboard, CPU, DVD, etc.) have already increased the cost of a typical laptop. Moreover, the addition of the micro-projector can consume energy greatly and increase weight. In addition, the pivotal display can block the sight when viewing the screen. furthermore, the micro-projector is high in cost and low in resolution. Thus, the need for improvement still exists.

### SUMMARY OF THE INVENTION

It is therefore one object of the invention to provide a wireless keyboard in cooperation with a personal computer (PC) having a display, comprising a housing; a plurality of keys mounted on the housing; a micro-projector pivotably mounted on a front end of the housing; a camera pivotably mounted on the front end of the housing besides the micro-projector; and a touchpad mounted besides the keys.

The above and other objects, features and advantages of the invention will become apparent from the following detailed description taken with the accompanying drawings.

### BRIEF DESCRIPTION OF THE DRAWINGS

FIG. 1 is a perspective view of a wireless keyboard according to the invention, a PC, and a display;

FIG. 2 is a perspective view showing an operation of the camera;

FIG. 3 is a perspective view showing an operation of the micro-projector;

FIG. 4 is a block diagram of the micro-projector;

FIG. 5 is a block diagram of the camera; and

FIG. 6 is a longitudinal sectional view of the touchpad.

### DETAILED DESCRIPTION OF THE INVENTION

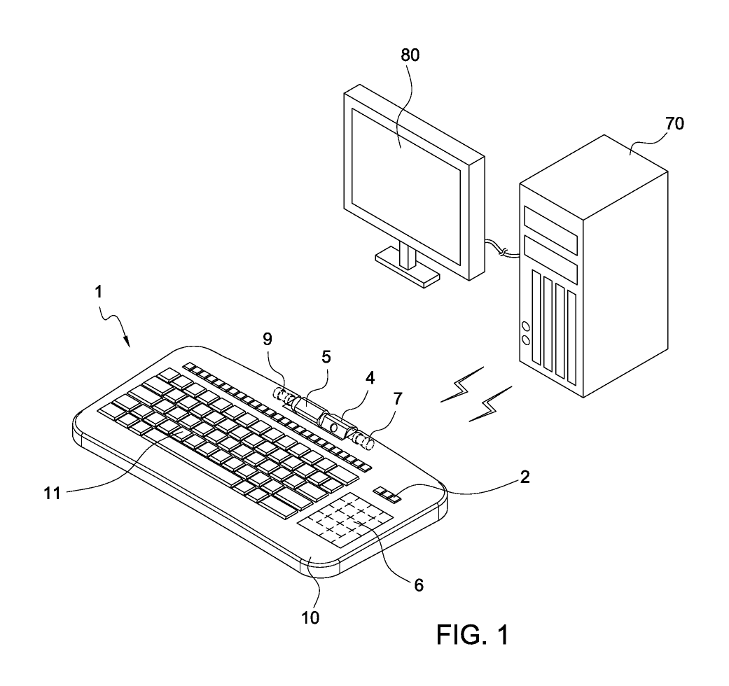

Referring to FIGS. 1 to 6, a wireless keyboard 1 in accordance with the invention is shown. The keyboard 1 and a display (e.g., LCD) 80 are parts of a PC 70. The keyboard 1 is in communication with the PC 70 by means of Bluetooth, infrared (IR) or the like as known in the art. Alternatively, the wireless keyboard 1 is replaced by a keyboard connected to the PC 70 by wire in other embodiments. The wireless keyboard 1 comprises the following components as discussed in detail below.

A housing 10 is provided with a plurality of keys 11 mounted thereon. A micro-projector 4 is pivotably mounted on a front end of the housing 10 by means of a pivot axis 7. Hence, the micro-projector 4 is adapted to adjust its projection angle. A camera (e.g., digital camera) 5 is pivotably mounted on the front end of the housing 10 besides the micro-projector 4 by means of the pivot axis 9. Hence, the camera 5 is adapted to adjust its picture taking angle.

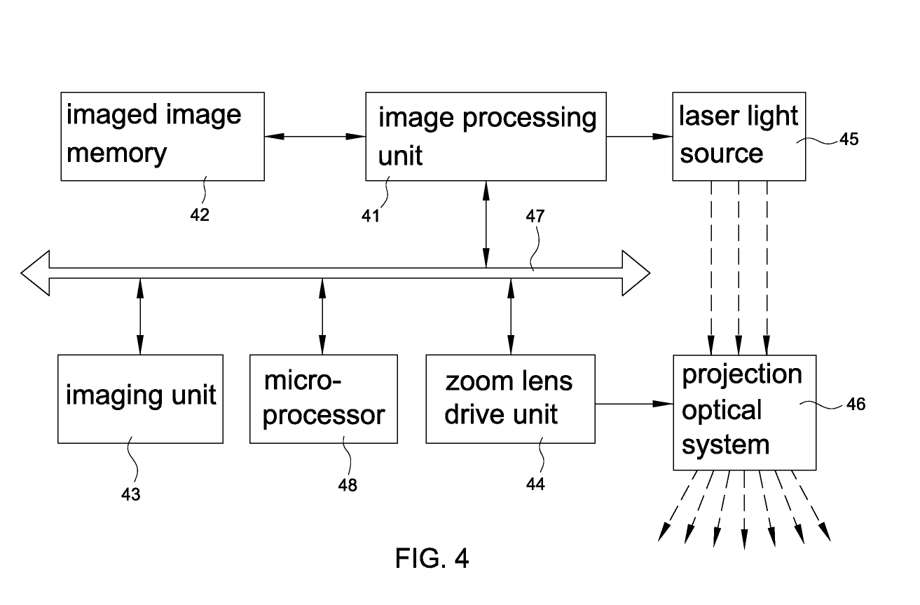

The micro-projector 4 may be implemented as one employing LED (light emitting diode) based DLP (digital light processing), LCOS (liquid crystal on silicon), or laser based projection technology (as implemented by the invention as shown in FIG. 4). Components (e.g., keys, printed circuit board, springs, etc.) of the wireless keyboard 1 are known in the art. Therefore, their description is omitted herein for the sake of brevity. A switch 2 is provided to the right of the keys 11 and a touchpad 6 is provided below the switch 2. A user may manually press the switch 2 to switch to picture taking mode, projection mode, or computer operating mode. The micro-projector 4, the camera 5, and the touchpad 6 are subjects of the invention which will be described in detail below.

As shown in FIG. 4, the micro-projector 4 comprises an image processing unit 41 for processing images, an imaged image memory 42 electrically connected to the image processing unit 41 for storing images sent therefrom or sending images to the image processing unit 41 as instructed, an imaging unit 43 for imaging the projected images, a zoom lens drive unit 44, a laser light source 45 for emitting highly collimated laser light with the images sent from the image processing unit 41 being projected, a projection optical system 46 for receiving the laser light and projecting the images contained therein onto a screen as instructed by the zoom lens drive unit 44, a bus 47 electrically connected to the image processing unit 41, the imaging unit 43, and the zoom lens drive unit 44, and a microprocessor 48 electrically connected to the bus 47 for controlling their operations. Laser based projection technology is adopted by the micro-projector 4. Hence, the micro-projector 4 has the advantages of less light loss, quality images and high brightness.

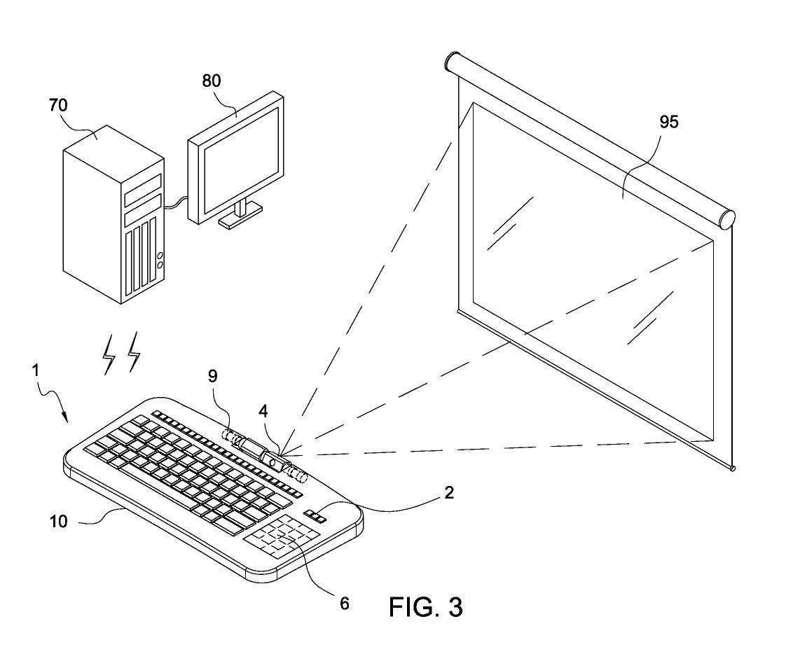

In one use mode such as in a meeting or briefing, a user may rotatably pivot the micro-projector 4 to adjust its projection angle in order to project what shown on the display 80 onto a screen 95 hanged on a wall. In detail, after turning on the PC 70, the microprocessor 48 is activated to instruct the image processing unit 41 to retrieve images from the imaged image memory 42, instruct the imaging unit 43 to image via the image processing unit 41, instruct the laser light source 45 to emit collimated laser light, and activate the projection optical system 46 via the zoom lens drive unit 44. As a result, images are shown on the screen 95 by projecting (see FIG. 3). It is envisaged by the invention that quality images can be seen on the screen 95 by adjusting the projection angle of the micro-projector 4. It is further envisaged by the invention that quality images can be seen on the screen 95.

Regarding DLP (as implemented by another embodiment of the micro-projector 4), it is a technology developed by Texas Instruments for being used in televisions (TVs) and video projectors. In DLP projectors, the image is created by microscopically small mirrors laid out in a matrix on a semiconductor chip, known as a Digital Micromirror Device (DMD). Each mirror represents one or more pixels in the projected image. The number of mirrors corresponds to the resolution of the projected image (often half as many mirrors as the advertised resolution due to wobulation). 800×600, 1024×768, 1280×720, and 1920×1080 (HDTV) matrices are some common DMD sizes. These mirrors can be repositioned rapidly to reflect light either through the lens or on to a heat sink. Rapidly toggling the mirror between these two orientations (essentially on and off) produces grayscales, controlled by the ratio of on-time to off-time. In detail, the mirrors can be individually rotated +10 degree to an on state or −10 degree to an off state. In the on state, light from the projector bulb is reflected into the lens making the pixel appear bright on the screen. In the off state, the light is directed elsewhere (usually onto a heat sink), making the pixel appear dark.

For DLP based projectors and TVs, they have the following advantages: Smooth, jitter-free images. Perfect geometry and excellent grayscale linearity achievable. Great ANSI contrast. No possibility of screen burn-in. Less “screen-door effect” than with LCD projectors. DLP rear projection TVs generally have a smaller form factor than comparable CRT projectors. The use of a replaceable light source means a potentially longer life than CRTs and plasma displays. Lighter weight than LCD and plasma televisions. Strong color performance. DLP projectors do not suffer from “Color Decay” often seen with LCD projectors in which the image on the screen turns yellow after extended periods of usage.

Regarding LCOS (as implemented by a further embodiment of the micro-projector 4), it is a “micro-projection” or “micro-display” technology typically applied in projection televisions. It is a reflective technology similar to DLP projectors; however, it uses liquid crystals instead of individual mirrors. By way of comparison, LCD projectors use transmissive LCD chips, allowing light to pass through the liquid crystal. In LCOS, liquid crystals are applied directly to the surface of a silicon chip coated with an aluminized layer, with some type of passivation layer, which is highly reflective.

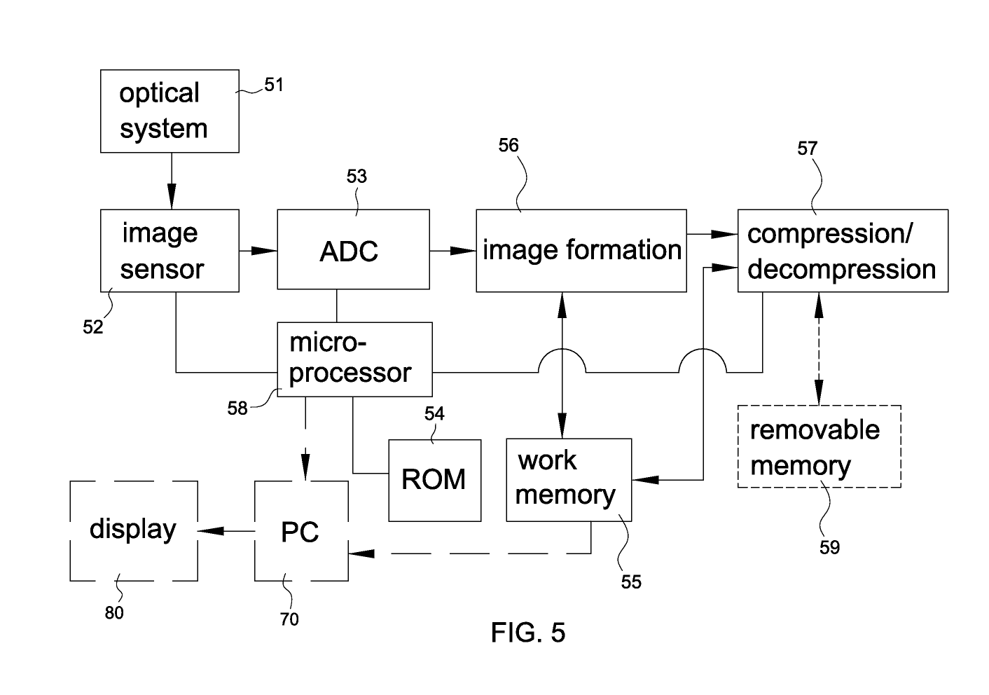

As shown in FIG. 5, the camera 5 comprises an optical system 51 for taking pictures, an image sensor 52 for sensing pictures taken by the optical system 51, an ADC (analog to digital converter) 53 for converting analog signals of the pictures into digital signals, an image formation 56 for transforming the digital signals into images, a ROM (read-only memory) 54 for storing software programs required for activating the camera 5, a work memory 55 for temporarily storing the images, a compression/decompression 57 for compressing or decompressing the images so as to be further stored in a removable memory (e.g., USB stick) 59, and a microprocessor 58 electrically connected to the image sensor 52, the ADC 53, the compression/decompression 57, and the ROM 54 for controlling their operations. Further, the microprocessor 58 may instruct the compression/decompression 57 to send the images stored in the work memory 55 to the PC 70 which in turn displays same on the display 80.

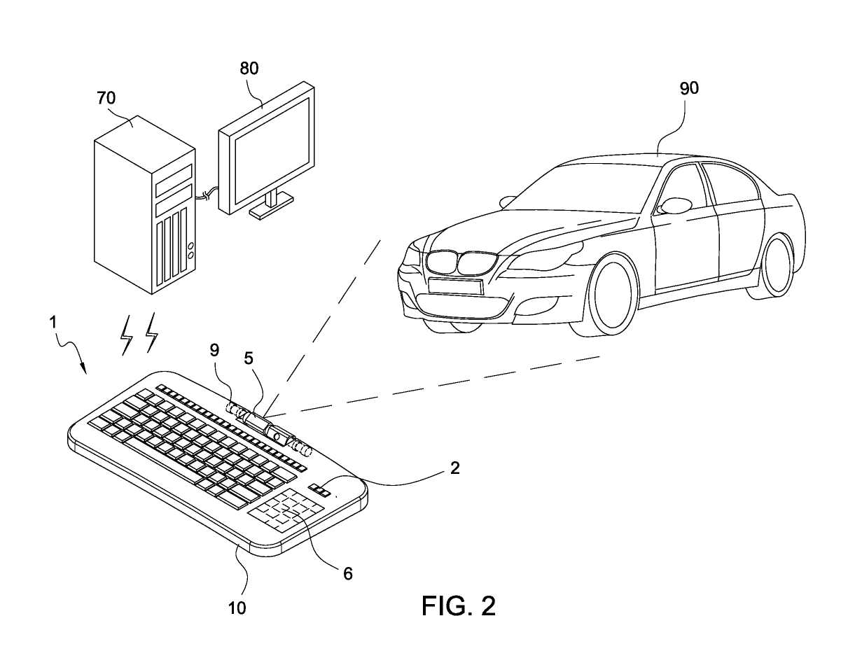

As shown in FIG. 2, after turning on the PC 70, for taking a picture a user may operate the wireless keyboard 1 and the camera 5 (i.e., the optical system 51 as instructed by the microprocessor 58) to take a picture of an object 90. The taken picture is then sent to the ADC 53 to convert analog signals of the pictures into digital signals. Next, the image formation 56 transforms the digital signals into images. The work memory 55 may temporarily store the images. The compression/decompression 57 may compress or decompress the images sent from the image formation 56 and/or the work memory 55 so as to be further sent to the PC 70 via the work memory 55. Finally, the PC 70 sends the images to the display 80 for display. It is envisaged by the invention that quality images can be seen on the display 80 by adjusting the picture taking angle of the camera 5. It is further envisaged by the invention that quality images can be seen on the display 80.

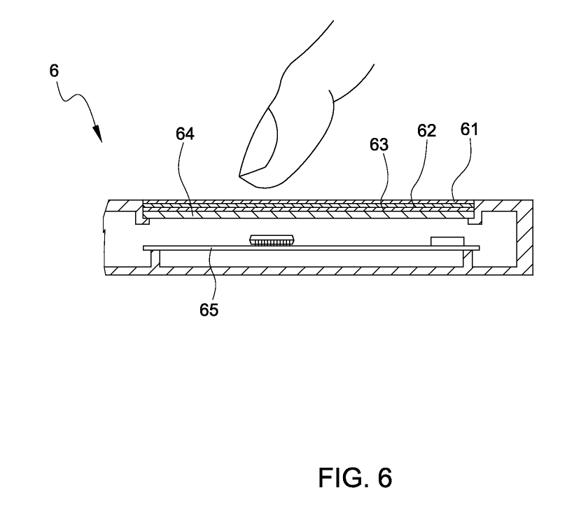

As shown in FIG. 6, the touchpad 6 comprises, from top to bottom, a membrane 61, a first conductive layer 62, a second conductive layer 63, a digitizer 64, and a printed circuit board (PCB) 65. The membrane 61 is printed with a plurality of virtual keys and numerals. The first conductive layer 62 is formed with a plurality of sensor zones arranged as matrix and corresponding to the virtual keys and numerals of the membrane 61. The second conductive layer 63 is formed with a plurality of sensor zones arranged as matrix and corresponding to sensor zones of the first conductive layer 62. Hence, a capacitive conductor is formed. The digitizer 64 is an electromagnetic sensor element. The PCB 65 is electrically connected to the first conductive layer 62, the second conductive layer 63, and the digitizer 64. The touchpad 6 is adapted to sense a finger pressing on the membrane 61 or a finger movement on the membrane 61 similar to mouse operation.

The invention has the following advantages: More options are provided for user selection. Mouse operation simulation by the provision of the touchpad. Compactness. Less power consumption. Quality images.

While the invention herein disclosed has been described by means of specific embodiments, numerous modifications and variations could be made thereto by those skilled in the art without departing from the scope and spirit of the invention set forth in the claims.

What is claimed is:

1. A wireless keyboard in cooperation with a personal computer (PC) having a display, comprising:
a housing;
a plurality of keys mounted on the housing;
a micro-projector pivotably mounted on a front end of the housing;
a camera pivotably mounted on the front end of the housing besides the micro-projector; and
a touchpad mounted besides the keys.

2. The wireless keyboard of claim 1, wherein the micro-projector comprises an image processing unit for processing images, an imaged image memory electrically connected to the image processing unit for storing the images sent therefrom or sending the images to the image processing unit, an imaging unit for imaging the images, a zoom lens drive unit, a laser light source for emitting collimated laser light with the images sent from the image processing unit being projected, a projection optical system for receiving the laser light and projecting the images contained therein onto a screen as instructed by the zoom lens drive unit, a bus electrically connected to the image processing unit, the imaging unit, and the zoom lens drive unit, and a microprocessor electrically connected to the bus for controlling operations of the image processing unit, the imaging unit, and the zoom lens drive unit.

3. The wireless keyboard of claim 1, wherein the micro-projector is implemented as one employing LED (light emitting diode) based DLP (digital light processing).

4. The wireless keyboard of claim 1, wherein the micro-projector is implemented as one employing LCOS (liquid crystal on silicon).

5. The wireless keyboard of claim 1, wherein the micro-projector is pivotably mounted on the front end of the housing by means of a pivot axis.

6. The wireless keyboard of claim 1, wherein the camera comprises an optical system for taking pictures, an image sensor for sensing the pictures taken by the optical system, an ADC (analog to digital converter) for converting analog signals of the pictures into digital signals, an image formation for transforming the digital signals into images, a ROM (read-only memory) for storing software programs required for activating the camera, a work memory for temporarily storing the images, and a microprocessor electrically connected to the image sensor, the ADC, and the ROM for controlling their operations and being capable of instructing the work memory to send the images stored therein to the PC which in turn displays same on the display.

7. The wireless keyboard of claim 5, wherein the camera is pivotably mounted on the front end of the housing by means of a pivot axis.

8. The wireless keyboard of claim 1, further comprising a switch beside the keys, the switch being adapted to press to switch to a picture taking mode, a projection mode, or a computer operating mode.

9. The wireless keyboard of claim 1, wherein the touchpad comprises, from top to bottom, a membrane, a first conductive layer, a second conductive layer, a digitizer, and a printed circuit board (PCB).

10. The wireless keyboard of claim 9, wherein the membrane is printed with a plurality of virtual keys and numerals, the first conductive layer is formed with a plurality of sensor zones arranged as a matrix and corresponding to the virtual keys and numerals of the membrane, and the second conductive layer is formed with a plurality of sensor zones arranged as a matrix and corresponding to the sensor zones of the first conductive layer so that a capacitive conductor is formed, wherein the digitizer is an electromagnetic sensor element, and wherein the PCB is electrically connected to the first conductive layer, the second conductive layer, and the digitizer.
